(19) United States
(12) Patent Application Publication
(10) Pub. No.: US 2005/0124522 A1
(43) Pub. Date: Jun. 9, 2005

(54) Colour-safe fabric treatment compositions

(75) Inventors: Deborah Jane Cooke, Chester (GB); Sarah Dixon, Merseyside (GB); Adelle Louise Killey, Wirral (GB); John Oakes, Cheshire (GB)

Correspondence Address: KIRKPATRICK & LOCKHART NICHOLSON GRAHAM LLP, 535 SMITHFIELD STREET, PITTSBURGH, PA, 15222, US

(73) Assignee: Carnegie Mellon University, Pittsburgh, PA (US)

(21) Appl. No.: 10/485,625

(22) PCT Filed: Jul. 30, 2002
(86) PCT No.: PCT/EP02/08537

(30) Foreign Application Priority Data
Aug. 2, 2001 (GB) 0118936.4

(51) Int. Cl. C11D 3/00

(52) U.S. Cl. 510/314

(57) ABSTRACT

A composition comprising: a dye transfer inhibition agent, and, a ligand having the structure of formula (I), wherein: B₁, B₃ and B₄ each represent a bridging group having zero, one two or three carbon containing nodes for substitution, and B₂ represents a bridging group having at least one carbon containing node for substitution, each said node containing a C(R), C(R₁)(R₂) or C(R)₂; each R substituent is the same is the same or different from the remaining R substituents and (1) is selected from the group consisting of alkyl, alkenyl, cycloalkyl, cycloalkenyl, aryl, alkynyl, alkylaryl, halogen, alkoxy, phenoxy and combinations thereof, or (2) form a substituted or unsubstituted benzene ring of which two carbons on the ring form nodes in the B-unit. Preferably further comprising surfactant and builder, optional peroxygen source. Preferred dye transfer inhibition agents are dye binding polymers selected from polymers and co-polymers of vinylpyrrolidone, vinylpyridine N-oxide, and vinylimidazole, and mixtures thereof.

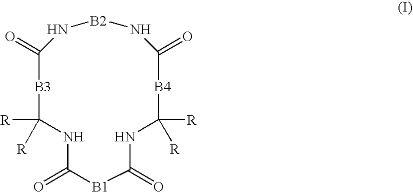

### FIELD OF THE INVENTION

The present invention relates to the use of certain macrocyclic metal-ligand complexes as bleaching catalysts in colour-safe fabric treatment compositions. In particular it relates to use of catalyst containing the ligand in combination with dye transfer inhibition (DTI) polymers.

### BACKGROUND OF THE INVENTION

Oxidation catalysts comprising metal-complexes are well known. One class being macrocyclic ligands, which co-ordinate with a transition metal ion. Such catalysts have been used in laundry compositions as parts of a bleaching system. These catalysts activate H₂O₂ or other peroxygen sources in water, and are effective at neutral to basic pH.

A particular catalyst is disclosed in WO 98/03263, filed 21 Jul. 1997, (Collins), which comprises a macrocyclic (tetra) amido N-donor. The macrocycle is capable of complexing with a metal ion, for example an iron III or IV. U.S. Pat. No. 5,853,428, filed 24 Feb. 1997, (Collins) discloses use of similar catalysts in laundry detergent compositions. Many other metal-based bleach catalysts are known.

Bleaching catalysts are of particular utility in the prevention of so-called ‘dye transfer’. This occurs when dyestuffs are released from one region of a cloth article during laundering and later re-adsorbed at another location or on another article. It is advantageous to bleach the dyestuff while it is in aqueous solution, thereby preventing or reducing its transfer.

In order to prevent transfer of dyes from one fabric substrate to another fabric substrate during cleaning processes, it is also known and often desired to include dye transfer inhibition agents in detergent compositions. The use of various polymers as dye transfer inhibitors (so-called ‘DTI’ polymers) in laundry detergent compositions and rinse conditioners has been described in the prior art. For example WO-A-0005334 discloses laundry detergents providing dye transfer inhibition benefits. Examples of known DTI polymers include polyvinyl pyrrolidone (PVP), and copolymers of N-vinylpyrrolidone and N-vinylimidazole (PVP/PVI).

### SUMMARY OF THE INVENTION

We have now determined that the combination of a particular class of metal-complexing ligand with a DTI polymer leads to particularly effective compositions for the treatment of fabrics which might otherwise be prone to damage due to dye transfer.

Accordingly, a first aspect of the present invention provides a composition comprising:
a) a dye transfer inhibition agent, and,
b) a ligand having the structure: 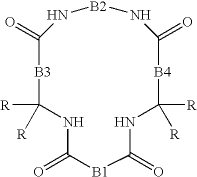
   wherein:
B₁, B₃ and B₄ each represent a bridging group having zero, one two or three carbon containing nodes for substitution, and B₂ represents a bridging group having at least one carbon containing node for substitution, each said node containing a C(R), C(R₁)(R₂) or C(R)₂,
each R substituent is the same is the same or different from the remaining R substituents and
   (i) is selected from the group consisting of alkyl, alkenyl, cycloalkyl, cycloalkenyl, aryl, alkynyl, alkylaryl, halogen, alkoxy, phenoxy and combinations thereof, or
   (ii) form a substituted or unsubstituted benzene ring of which two carbons on the ring form nodes in the B-unit.

A further aspect of the present invention subsists in those complexes, which have simple axial ligands (water or halide) and an elemental counter-ion (such as lithium). It is believed that these ligands are environmentally and toxicologically more acceptable than ligands such as trifluoroacetate, tetra-phenylphosphonium and tetra-ethylammonium.

Accordingly, a further aspect of the present invention provides a composition comprising:
a) a dye transfer inhibition agent, and,
b) a bleach activator having the structure: 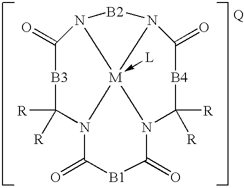
   wherein:
B₁, B₃ and B₄ each represent a bridging group having zero, one two or three carbon containing nodes for substitution, and B₂ represents a bridging group having at least one carbon containing node for substitution, each said node containing a C(R), C(R₁)(R₂) or C(R)₂,
each R substituent is the same is the same or different from the remaining R substituents, and
   (i) is selected from the group consisting of alkyl, alkenyl, cycloalkyl, cycloalkenyl, aryl, alkynyl, alkylaryl, halogen, alkoxy, phenoxy and combinations thereof, or
   (ii) form a substituted or unsubstituted benzene ring of which two carbons on the ring form nodes in the B-unit;
M is a transition metal ion;
L is an axial ligand; and,
Q is an alkali metal or tetra-alkyl ammonium or tetra-phenyl phosphonium counter-ion.

Preferably, the axial ligand is selected from the group consisting of water and halide. Particularly preferred axial ligands are water and chloride.

It is within the scope of the present invention to have a bleach activator, wherein M is selected from the group consisting of Fe, Mn, Cr, Cu, Co, Ni, Mo, V, Zn and W.

### DETAILED DESCRIPTION OF THE INVENTION

Throughout the description and claims generic groups are used, for example alkyl, alkoxy, aryl etc. Unless otherwise specified the following are preferred group restrictions that may be applied to generic groups found within compounds disclosed herein:

alkyl: linear and branched C1-C8-alkyl, preferably C1-C6;

alkenyl: C2-C8-alkenyl, preferably C3-C6;

cycloalkyl: C3-C8-cycloalkyl, preferably C6-C8;

cycloalkenyl: C4-12-cycloalkenyl (preferably C4-C8) having a single cyclic ring or multiple condensed rings and at least one point of internal unsaturation which can be optionally substituted with from 1 to 3 C1-C8-alkyl groups;

aryl: selected from homoaromatic compounds having a molecular weight under 300, preferably selected from group consisting of: phenyl; biphenyl; naphthalenyl; anthracenyl; and phenanthrenyl;

alkynyl: C2-C12-alkynyl; alkylaryl: C1-12-alkylaryl, wherein the aryl selected from homoaromatic compounds having a molecular weight under 300;

halogen: selected from the group consisting of: F; Cl; Br and I, preferably F and Cl; and,

alkoxy: C1-C6-alkoxy, preferably C1-C4.

The present invention extends to fully formulated products containing the catalysts disclosed herein and DTI polymers. Such products will generally contain a detergent active and will typically contain one or more builders together with the typical additives used in detergent compositions.

The present invention also extends to a commercial package comprising a bleach activator as defined together with a DTI polymer and instructions for its use.

Typically, compositions of the present invention will comprise a peroxygen source.

Further aspects of the present invention and preferred embodiments are described below.

Ligands:

Preferred compounds of the present invention have R=methyl. B3 and B4 are preferably absent, the two related sides of the ring being derived from a ‘classical’ amino acid in which the amino group is located on the alpha-carbon. A preferred starting amino acid is 2-amino iso-butyric acid. (H₂N—C(CH₃)₂—COOH).

The transition metal is preferably selected from groups VI, VII, VIII, IX, X and XI of the periodic table. More preferably the metal is selected from the group consisting of Fe, Mn, Cr, Cu, Co, Ni, Mo, V, Zn and W. Particularly preferably the metal is selected from the group comprising: Fe, Mn, Cu and Co. Iron is the most preferred metal.

Suitable counter ions are tetra-alkyl ammonium, tetra-phenyl phosphonium, K, Li or Na, most preferably lithium.

The most preferred compound is that in which the ligand is 5,6-benzo-3,8,11,13-tetraoxo-2,2,9,9,12,12-hexamethyl-1,4,7,10-tetraaza-cyclo-tridecane as shown below as the Fe form, the axial ligand ‘L’ is water or preferably chloride. The counter-ion ‘Q’ is preferably lithium. The ligand is also known as 3,4,8,9-tetrahydro-3,3,6,6,9,9-hexa-methyl-1H-1,4,8,11-benzotetraazocyclotridecane-2,5,7,10(6H,11H) tetrone.

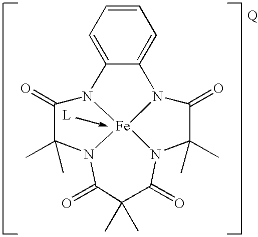

The composition is preferably used in a laundry wash liquor, preferably an aqueous wash liquor. The amount of catalyst in the composition according to the present invention is sufficient to provide a concentration in the wash liquor of generally 0.005 μm to 100 μm, preferably from 0.025 μM to 50 μM, more preferably from 0.05 μM to 10 μM.

DTI Polymers:

Any suitable dye-transfer inhibition (DTI) agents may be used in accordance with the present invention. Generally, such dye-transfer inhibiting agents include polyvinyl pyrrolidone polymers, polyamine N-oxide polymers, copolymers of N-vinylpyrrolidone and N-vinylimidazole, manganese pthalocyanine, peroxidases, and mixtures thereof. It is also possible to use zwitterionic polymers, i.e. PCM-VPy (poly(N-carboxymethyl-4-vinylpyridinium chloride)].

Polyamine N-oxide polymers suitable for use herein contain units having the following structural formula: R-A_{X}-P; wherein P is a polymerizable unit to which an N-O group can be attached or the N-O group can form part of the polymerizable unit; A is one of the following structures: —NC(O)—, —C(O)O—, —S—, —O—, —N═; x is 0 or 1; and R is an aliphatic, ethoxylated aliphatic, aromatic, heterocyclic or alicyclic group or combination thereof to which the nitrogen of the N—O group can be attached or the N—O group is part of these groups, or the N—O group can be attached to both units. Preferred polyamine N-oxides are those wherein R is a heterocyclic group such as pyridine, pyrrole, imidazole, pyrrolidine, piperidine and derivatives thereof. The N—O group can be represented by the following general structures: N(O)(R′)₀₋₃, or ═N(O)(R′)₀₋₁, wherein each R′ independently represents an aliphatic, aromatic, heterocyclic or alicylic group or combination thereof; and the nitrogen of the N—O group can be attached or form part of any of the aforementioned groups. The amine oxide unit of the polyamine N-oxides has a pKa<10, preferably pKa<7, more preferably pKa<6.

Any polymer backbone can be used provided the amine oxide polymer formed is water-soluble and has dye transfer inhibiting properties. Examples of suitable polymeric backbones are polyvinyls, polyalkylenes, polyesters, polyethers, polyamides, polyimides, polyacrylates and mixtures thereof. These polymers include random or block copolymers where one monomer type is an amine N-oxide and the other monomer type is an N-oxide. The amine N-oxide polymers typically have a ratio of amine to the amine N-oxide of 10:1 to 1:1,000,000. However, the number of amine oxide groups present in the polyamine oxide polymer can be varied by appropriate copolymerization or by an appropriate degree of N-oxidation. The polyamine oxides can be obtained in almost any degree of polymerisation. Typically, the average molecular weight is within the range of 500 to 1,000,000; more preferably 1,000 to 500,000; most preferably 5,000 to 100,000. This preferred class of materials is referred to herein as “PVPy-NO”. A preferred polyamine N-oxide is poly(4-vinylpyridine-N-oxide) which as an average molecular weight of about 50,000 and an amine to amine N-oxide ratio of about 1:4.

Block or random co-polymers of N-vinylpyrrolidone and N-vinylimidazole polymers (as a class, referred to as “PVP/PVI”) are also preferred. Preferably the PVP/PVI has an average molecular weight range from 5,000 to 1,000,000, more preferably from 5,000 to 200,000, and most preferably from 10,000 to 20,000, as determined by light scattering as described in Barth, et al., Chemical Analysis, Vol. 113. “Modern Methods of Polymer Characterisation”). The preferred PVP/PVI copolymers typically have a molar ratio of N-vinylimidazole to N-vinylpyrrolidone from 1:1 to 0.2:1, more preferably from 0.8:1 to 0.3:1, most preferably from 0.6:1 to 0.4:1. These copolymers can be either linear or branched. Suitable PVP/PVI polymers include Sokalan™ HP56, available commercially from BASF, Ludwigshafen, Germany.

Also preferred as dye transfer inhibition agents are polyvinylpyrrolidone polymers (“PVP”) having an average molecular weight of from about 5,000 to about 400,000, preferably from about 5,000 to about 200,000, and more preferably from about 5,000 to about 50,000. PVP's are disclosed for example in EP-A-262,897 and EP-A-256,696. Suitable PVP polymers include Sokalan™ HP50, available commercially from BASF. Compositions containing PVP can also contain polyethylene glycol (“PEG”) having an average molecular weight from about 500 to about 100,000, preferably from about 1,000 to about 10,000. Preferably, the ratio of PEG to PVP on a ppm basis delivered in wash solutions is from about 2:1 to about 50:1, and more preferably from about 3:1 to about 10:1.

Also suitable as dye transfer inhibiting agents are those from the class of modified polyethyleneimine polymers, as disclosed for example in WO-A-0005334. These modified polyethyleneimine polymers are water-soluble or dispersible, modified polyamines. Modified polyamines are further disclosed in U.S. Pat. No. 4,548,744; U.S. Pat. No. 4,597,898; U.S. Pat. No. 4,877,896; U.S. Pat. No. 4,891, 160; U.S. Pat. No. 4,976,879; U.S. Pat. No. 5,415,807; GB-A-1,537,288; GB-A-1,498,520; DE-A-28 29022; and JP-A-06313271.

Nitrogen-containing, dye binding, DTI polymers are preferred. Preferably the bleaching composition according to the present invention comprises a dye transfer inhibition agent selected from polyvinylpyrridine N-oxide (PVPy-NO), polyvinyl pyrrolidone (PVP), polyvinyl imidazole, N-vinylpyrrolidone and N-vinylimidazole copolymers (PVP/PVI), copolymers thereof, and mixtures thereof.

The amount of dye transfer inhibition agent in the composition according to the present invention will be from 0.01 to 10%, preferably from 0.02 to 5%, more preferably from 0.03 to 2 %, by weight of the composition.

Peroxygen Source:

It is greatly preferred that the compositions of the present invention are pre-formulated with a source of hydroperoxyl species.

It is preferable that the composition contains a peroxygen bleach or a peroxy-based or -generating system. The peroxy bleach may be a compound which is capable of yielding hydrogen peroxide in aqueous solution. Hydrogen peroxide sources are well known in the art. They include the inorganic peroxides, for example alkali metal peroxides, organic peroxides for example as urea peroxide, and inorganic persalts, such as the alkali metal perborates, percarbonates, perphosphates, persilicates and persulphates. Mixtures of two or more such compounds may also be suitable.

Typical levels of peroxygen source in fully formulated composition will range from 0.05-55 wt. % with 1-40 wt. % being particularly preferred and 1-25 wt. % being most particularly preferred.

Typical levels of peroxygen source (as hydrogen peroxide equivalents) in fully formulated composition will be such that the in-use concentration will range from 0.005 mM to 100 mM with 0.025 mM to 50 mM being particularly preferred and 0.05 mM to 10 mM being most particularly preferred.

Preferred peroxygen sources include percarbonate and perborate.

Particularly preferred are sodium perborate tetrahydrate and, especially, sodium perborate monohydrate. Sodium perborate monohydrate is preferred because of its high active oxygen content. Sodium percarbonate may also be preferred for environmental reasons.

Another suitable hydrogen peroxide generating system is a combination of a C₁-C₄ alkanol oxidase and a C₁-C₄ alkanol, especially a combination of methanol oxidase (MOX) and ethanol. Such combinations are disclosed in WO-A-9507972, which is incorporated herein by reference.

Alkylhydroxy peroxides are another class of peroxy bleaching compounds. Examples of these materials include cumene hydroperoxide and t-butyl hydroperoxide.

Organic peroxyacids may also be suitable as the peroxy bleaching compound. Such materials normally have the general formula: 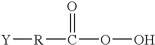
wherein R is an alkyl- or alkylidene- or substituted alkylene group containing from 1 to about 20 carbon atoms, optionally having an internal amide linkage; or a phenylene or substituted phenylene group; and Y is hydrogen, halogen, alkyl, aryl, an imido-aromatic or non-aromatic group, a —COOH or —COOOH group or a quaternary ammonium group.

Typical monoperoxy acids useful herein include, for example:
(i) peroxybenzoic acid and ring-substituted peroxybenzoic acids, e.g. peroxy-naphthoic acid;
(ii) aliphatic, substituted aliphatic and arylalkyl monoperoxyacids, e.g. peroxylauric acid, peroxystearic acid and N,N-phthaloylaminoperoxy caproic acid (PAP); and
(iii) 6-octylamino-6-oxo-peroxyhexanoic acid.

Typical diperoxyacids useful herein include, for example:
(i) 1,12-diperoxydodecanedioic acid (DPDA);
(ii) 1,9-diperoxyazelaic acid;
(iii) diperoxybrassylic acid; diperoxysebacic acid and diperoxyisophthalic acid;
(iv) 2-decyldiperoxybutane-1,4-dioic acid; and
(v) 4,4I-sulphonylbisperoxybenzoic acid.

Also inorganic peroxyacid compounds are suitable, such as for example potassium monopersulphate (MPS). If organic or inorganic peroxyacids are used as the peroxygen compound, the amount thereof will normally be within the range of about 2-10% by weight, preferably from 4-8% by weight.

Peroxyacid bleach precursors are known and amply described in literature, such as in GB-A-836988; GB-A-864,798; GB-A-907,356; GB-A-1,003,310 and GB-A-1,519,351; DE-A-3,337,921; EP-A-0,185,522; EP-A-0,174,132; EP-A-0,120,591; and U.S. Pat. No. 1,246,339; U.S. Pat. No. 3,332,882; U.S. Pat. No. 4,128,494; U.S. Pat. No. 4,412,934 and U.S. Pat. No. 4,675,393.

Another useful class of peroxyacid bleach precursors is that of the cationic i.e. quaternary ammonium substituted peroxyacid precursors as disclosed in U.S. Pat. No. 4,751,015 and U.S. Pat. No. 4,397,757, in EP-A-0,284,292 and EP-A-331,229.

Examples of peroxyacid bleach precursors of this class are:
2-(N,N,N-trimethyl ammonium) ethyl sodium-4-sulphophenyl carbonate chloride—(SPCC);
N-octyl,N,N-dimethyl-N₁₀-carbophenoxy decyl ammonium chloride—(ODC);
3-(N,N,N-trimethyl ammonium) propyl sodium-4-sulphophenyl carboxylate; and
N,N,N-trimethyl ammonium toluyloxy benzene sulphonate.

A further special class of bleach precursors is formed by the cationic nitriles as disclosed in EP-A-303,520; EP-A-458,396 and EP-A-464,880.

Of the above classes of bleach precursors, the preferred classes are the esters, including acyl phenol sulphonates and acyl alkyl phenol sulphonates; the acyl-amides; and the quaternary ammonium substituted peroxyacid precursors including the cationic nitriles.

Examples of said preferred peroxyacid bleach precursors or activators are sodium-4-benzoyloxy benzene sulphonate (SBOBS); N,N,N′N′-tetraacetyl ethylene diamine (TAED); sodium-1-methyl-2-benzoyloxy benzene-4-sulphonate; sodium-4-methyl-3-benzoloxy benzoate; 2-(N,N,N-trimethyl ammonium) ethyl sodium-4-sulphophenyl carbonate chloride (SPCC); trimethyl ammonium toluyloxy-benzene sulphonate; sodium nonanoyloxybenzene sulphonate (SNOBS); sodium 3,5,5-trimethyl hexanoyl-oxybenzene sulphonate (STHOBS); and the substituted cationic nitriles.

Of the peracid precursors, TAED and SNOBS are preferred. However, peroxide based bleaching systems according to the present invention are markedly preferred to peracid based systems.

When present, the precursors are used at levels of up to 12%, preferably up to 5%, by weight of the composition.

Surfactants and Builders:

The present invention has particular application in detergent bleaching, especially for laundry cleaning. Accordingly, the composition preferably contains a surface-active material, optionally together with detergency builder.

The composition may contain a surface-active material in an amount, for example, of from 10 to 50% by weight.

The surface-active material may comprise materials which are naturally derived, such as soap, or a synthetic material selected from anionic, nonionic, amphoteric, zwitterionic, cationic actives and mixtures thereof. Many suitable actives are commercially available and are fully described in the literature, for example in “Surface Active Agents and Detergents”, Volumes I and II, by Schwartz, Perry and Berch.

Typical synthetic anionic surface-actives are usually water-soluble alkali metal salts of organic sulphates and sulphonates having alkyl groups containing from about 8 to about 22 carbon atoms, the term “alkyl” being used to include the alkyl portion of higher aryl groups.

Examples of suitable synthetic anionic detergent compounds are sodium and ammonium alkyl sulphates, especially those obtained by sulphating higher (C₈-C₁₈) alcohols produced, for example, from tallow or coconut oil; sodium and ammonium alkyl (C₉-C₂₀) benzene sulphonates, particularly sodium linear secondary alkyl (C₁₀-C₁₅) benzene sulphonates; sodium alkyl glyceryl ether sulphates, especially those ethers of the higher alcohols derived from tallow or coconut oil fatty acid monoglyceride sulphates and sulphonates; sodium and ammonium salts of sulphuric acid esters of higher (C₉-C₁₈) fatty alcohol alkylene oxide, particularly ethylene oxide, reaction products; the reaction products of fatty acids such as coconut fatty acids esterified with isethionic acid and neutralised with sodium hydroxide; sodium and ammonium salts of fatty acid amides of methyl taurine; alkane monosulphonates such as those derived by reacting alpha-olefins (C₈-C₂₀) with sodium bisulphite and those derived by reacting paraffins with SO₂ and C₁₂ and then hydrolysing with a base to produce a random sulphonate; sodium and ammonium (C₇-C₁₂) dialkyl sulphosuccinates; and olefin sulphonates, which term is used to describe material made by reacting olefins, particularly (C₁₀-C₂₀) alpha-olefins, with SO₃ and then neutralising and hydrolysing the reaction product. The preferred anionic detergent compounds are sodium (C₁₀-C₁₅) alkylbenzene sulphonates (C10-C15 LAS), and sodium (C₁₆-C₁₈) alkyl ether sulphates (C16-C18 LES).

Examples of suitable nonionic surface-active compounds which may be used, preferably together with the anionic surface-active compounds, include, in particular, the reaction products of alkylene oxides, usually ethylene oxide, with alkyl (C₆-C₂₂) phenols, generally 5-25 EO, i.e. 5-25 units of ethylene oxides per molecule; and the condensation products of aliphatic (C₈-C₁₈) primary or secondary linear or branched alcohols with ethylene oxide, generally 2-30 EO. Other so-called nonionic surface-actives include alkyl polyglycosides, sugar esters, long-chain tertiary amine oxides, long-chain tertiary phosphine oxides and dialkyl sulphoxides.

Amphoteric or zwitterionic surface-active compounds can also be used in the compositions of the invention but this is not normally desired owing to their relatively high cost. If any amphoteric or zwitterionic detergent compounds are used, it is generally in small amounts in compositions based on the much more commonly used synthetic anionic and nonionic actives.

The composition will preferably comprise from 1 to 15% wt of anionic surfactant and from 10 to 40% by weight of nonionic surfactant.

Preferred embodiments of the present invention comprise a mixed active system which comprises both anionic and nonionic surfactants. It is believed that the catalysts become less effective as the level of nonionic approaches 100% on surfactant. Conversely, where nitrogen-containing, dye binding, DTI polymers are used, the effectiveness of these polymers is reduced at high levels of anionic surfactant.

It is preferable that the level of anionic surfactant (on total surfactant) ranges from 10-90% wt and that the level of nonionic ranges from 90-10% wt (on total surfactant). It is especially preferred to use 30-60% wt/surfactant of anionic surfactant selected from: LAS, PAS, soap and mixtures thereof, together with 70-40% wt/surfactant of ethoxylated alcohol nonionic surfactant.

The composition may also contain a detergency builder, for example in an amount of from about 5 to 80% by weight, preferably from about 10 to 60% by weight.

Builder materials may be selected from:
1) calcium sequestrant materials,
2) precipitating materials,
3) calcium ion-exchange materials and
4) mixtures thereof.

Examples of calcium sequestrant builder materials include alkali metal polyphosphates, such as sodium tripolyphosphate; nitrilotriacetic acid and its water-soluble salts; the alkali metal salts of carboxymethyloxy succinic acid, ethylene diamine tetraacetic acid, oxydisuccinic acid, mellitic acid, benzene polycarboxylic acids, citric acid; and polyacetal carboxylates as disclosed in U.S. Pat. No. 4,144,226 and U.S. Pat. No. 4,146,495.

Examples of precipitating builder materials include sodium orthophosphate and sodium carbonate.

Examples of calcium ion-exchange builder materials include the various types of water-insoluble crystalline or amorphous aluminosilicates, of which zeolites are the best known representatives, e.g. zeolite A, zeolite B (also known as zeolite P), zeolite C, zeolite X, zeolite Y and also the zeolite P-type as described in EP-A-0,384,070.

In particular, the composition may contain any one of the organic and inorganic builder materials, though, for environmental reasons, phosphate builders are preferably omitted or only used in very small amounts. Typical builders usable in the present invention are, for example, sodium carbonate, calcite/carbonate, the sodium salt of nitrilotriacetic acid, sodium citrate, carboxymethyloxy malonate, carboxymethyloxy succinate and water-insoluble crystalline or amorphous aluminosilicate builder materials, each of which can be used as the main builder, either alone or in admixture with minor amounts of other builders or polymers as co-builder.

It is preferred that the composition contains not more than 5% by weight of a carbonate builder, expressed as sodium carbonate, more preferably not more than 2.5-% by weight to substantially nil, if the composition pH lies in the lower alkaline region of up to 10.

Apart from the components already mentioned, the composition can contain any of the conventional additives in amounts of which such materials are normally employed in fabric washing detergent compositions. Examples of these additives include buffers such as carbonates, lather boosters, such as alkanolamides, particularly the monoethanol amides derived from palmkernel fatty acids and coconut fatty acids; lather depressants, such as alkyl phosphates and silicones; anti-redeposition agents, such as sodium carboxymethyl cellulose and alkyl or substituted alkyl cellulose ethers; stabilisers, such as phosphonic acid derivatives (i.e. DequestO types); fabric softening agents; inorganic salts and alkaline buffering agents, such as sodium sulphate and sodium silicate; and, usually in very small amounts, fluorescent agents; perfumes; enzymes, such as proteases, cellulases, lipases, amylases and oxidases; germicides and colourants.

When using a hydrogen peroxide source, such as sodium perborate or sodium percarbonate, as the bleaching compound, it is preferred that the composition contains not more than 5% by weight of a carbonate buffer, expressed as sodium carbonate, more preferable not more than 2.5% by weight to substantially nil, if the composition pH lies in the lower alkaline region of up to 10.

Of the additives, transition metal sequestrants such as EDTA and the phosphonic acid derivatives, e.g. ethylene diamine tetra-(methylene phosphonate)-EDTMP- are of special importance, as not only do they improve the stability of the catalyst/H₂O₂ system and sensitive ingredients, such as enzymes, fluorescent agents, perfumes and the like, but also improve the bleach performance, especially at the higher pH region of above 10, particularly at pH 10.5 and above. Other suitable transition metal sequestrants are known and can be chosen by those skilled in the art, for example aminocarboxylates, aminophosphonates. and polyfunctionally substituted aromatic chelating agents, as disclosed further in WO-A-98/39406. If present, the sequestrants are generally present in amounts of 0.001 to 15%, more preferably 0.01 to 3.0%, by weight of the composition.

The present invention may be conveniently embodied in a solid form of product, which includes both a powder or tablet form af product. Both of these forms may be homogeneous or non-homogeneous. For example tablets may comprise a plurality of discrete regions which include some ingredients only, while powders may comprise mixed granules of differing compositions.

### EXAMPLES

In order that the invention may be further and better understood it will be described in detail with reference to following non-limiting examples.

The catalyst referred to in the examples is the Fe complex of 3,4,8,9-tetrahydro-3.3,6,6,9,9-hexamethyl-1H-1,4,8,11-benzotetraazocyclotri-decane-2,5,7,10(6H,11H)tetrone, with lithium as the counter-ion and water as the axial ligand. This was synthesised in accordance with the method set out in our co-pending patent application WO 02/16330.

Washes were simulated in a shaker-bath at 40° C., using 30 minutes agitation in demineralimed water. Washes were followed by a cold running rinse (in demineralised water) and line drying. Typically, three replicates would be performed.

Unless otherwise noted, each shaker-bath pot contained:
a) a 13 cm×13 cm square of Mercerised white cotton sheeting that had previously been washed three times in Wirral water (12 degrees French hardness) using a non phosphate detergent.
b) 100 ml wash liquor comprising solutions of polymer (detailed below), catalyst (detailed below) and bleaching agent and suitable dye levels (detailed below) made up to 100 ml with demineralised water.
c) 0.7 g of a laundry detergent powder(equivalent to 7 g/l)

The powder had the following formulation (all percentages by weight):

| | |
|---|---|
| Sodium linear alkyl (C12) | 7.89% |
| benzene sulphonate | |
| Nonionic (C12-15) 7EO | 5.07% |
| Nonionic (C12-15) 3EO | 3.94% |
| Sodium tripolyphosphate | 29.97% |
| Sodium silicate | 7.9% |
| Sodium sulphate | 14.54% |
| Sodium hydrogen carbonate | 4.00% |
| Sodium carbonate | 8.83% |
| Minors and water | 17.86% |

For the individual dyes (Examples 1-16), dye was dosed at 1 ml of a 1 g/l dye solution.

Unless noted otherwise, all fabrics were measured after washing on a Datacolour™ SF600 Plus Spectraflash™ which was calibrated using the following settings:
UV Excluded—420 nm cut-off
Specular Included

Each monitor was measured through four thicknesses of cloth with the white tile as the reference standard. Each monitor was measured four times and the average of these four measurements was taken to be the value of that monitor.

LabCH values were taken and converted into delta E values by calculating the difference in L, a and b between the after wash measurements and those of an identical white cloth which had not been washed and then applying the equation:
ΔE=\sqrt{(ΔL²+Δa²+Δb²)}

These results were analysed for significance using the JMP statistical analysis program to do an analysis of variance on each set of samples and the average delta E calculated.

### Examples 1-16

The specific conditions for the examples were:

Ex. 1 and 7(Control)—no further additions.

Ex. 2 and 8 (Catalyst)—1 ml of a 0.00485 g/100 ml solution of the catalyst +1 ml of a H₂O₂ solution comprising 0.49 g of 35% H₂O₂ solution made up with demin water to 100 g.

Ex. 3 and 9 (PVP)—10 ml of a 0.35 g/l solution of PVP.

Ex. 5 and 13 (PVPy-NO)—5 ml of a 1.015 g/l solution of Texcare™ (ex. Clariant, 34.5% active).

Ex. 4 and 10 (PVP+Catalyst)—10 ml of a 0.35 g/l solution of PVP +1 ml of a 0.00485 g/100 ml solution of catalyst +1 ml of a H₂O₂ solution comprising 0.49 g of 35% H₂O₂ solution made up with demin water to 100 g.

Ex. 6 and 14 (PVPy-NO+Catalyst)—5 ml of a 1.015 g/l solution of Texcare™ (34.5% active) +1 ml of a 0.00485 g/100 ml solution of catalyst +1 ml of a H₂O₂ solution comprising 0.49 g of 35% H₂O₂ solution made up with demin water to 100 g.

Ex. 11 (0.75 PVP+catalyst)—7.5 ml of a 0.35 g/l solution of PVP+0.75 ml of a 0.00485 g/100 ml solution of catalyst+0.75 ml of a H₂O₂ solution comprising 0.49 g of 35% H₂O₂ solution made up with demineralised water to 100 g.

Ex. 12 (0.5 PVP+catalyst)—5 ml of a 0.35 g/l solution of PVP+0.5 ml of a 0.00485 g/100 ml solution of catalyst +0.5 ml of a H₂O₂ solution comprising 0.49 g of 35% H₂O₂ solution made up with demineralised water to 10 g.

Ex. 15 (0.75 PVPy-NO +catalyst)—3.75 ml of a 1.015 g/l solution of Texcare™ (34.5% active)+0.75 ml of a 0.00485 g/100 ml solution of catalyst+0.75 ml of a H₂O₂ solution comprising 0.49 g of 35% H₂O₂ solution made up with demineralised water to 10 g.

Ex.16 (0.5 PVPy-NO+catalyst)—2.5 ml of a 1.015 g/l solution of Texcare™ (34.5% active)+0.5 ml of a 0.00485 g/100 ml solution of catalyst +0.5 ml of a H₂O₂ solution comprising 0.49 g of 35% H₂O₂ solution made up with demineralised water to 100 g.

Three replicate measurements were taken of each sample. In these experiments, lower values of delta-E are indicative of better results as they show that less dye was transferred onto the white monitor cloth.

TABLE 1
Delta E of White Pickup Monitor after Wash

| | Delta E of White Pickup | | |
|---|---|---|---|
| | Monitor after Wash | | |
| | Direct | Direct | Direct |
| Example | Blue 98 | Red 89 | Green 26 |
| 1 (Control) | 26.27 | 32.72 | 25.95 |
| 2 (Catalyst) | 22.11 | 23.63 | 15.63 |
| 3 (PVP) | 25.94 | 24.22 | 8.65 |
| 4 (PVP + Catalyst) | 18.81 | 18.11 | 5.42 |
| 5 (PVPy-NO) | 15.63 | 19.73 | 6.87 |
| 6 (PVPy-NO + Catalyst) | 12.25 | 11.01 | 3.31 |

The results seen in Table 1 show that for the three dyes tested there is a benefit (i.e. a lower dye-transfer value is obtained) for the samples containing both catalyst and DTI polymer (examples 4 and 6) over either of the polymer (examples 3 and 5) or catalyst (example 2) treatments alone. An analysis of variance showed that these differences were significant.

Further results are shown in Table 2.

TABLE 2
Delta E of White Pickup Monitor after Wash

| | Delta E of White Pickup | |
|---|---|---|
| | Monitor after Wash | |
| Example | Direct Blue 98 | Direct Red 89 |
| 7 (Control) | 25.37 | 33.06 |
| 8 (Catalyst) | 20.83 | 21.45 |
| 9 (PVP) | 25.18 | 25.97 |
| 10 (PVP + Catalyst) | 18.62 | 20.70 |
| 11 (0.75 PVP + Catalyst) | 19.71 | 22.77 |
| 12 (0.5 PVP + Catalyst) | 21.39 | 24.54 |
| 13 (PVPy-NO) | 15.92 | 18.68 |
| 14 (PVPy-NO + Catalyst) | 12.91 | 11.05 |
| 15 (0.75 PVPy-NO + Catalyst) | 14.04 | 14.02 |
| 16 (0.5 PVPy-NO + Catalyst) | 15.94 | 19.40 |

Taking the differences between the examples it can be seen from Table 2 that for the DB98 the difference caused by the sum of the catalyst and PVP is less than the difference caused by PVP+catalyst at 100 & 75%

### Examples 17-22

Examples 17-22 look at mixed dye systems. The dye mixtures doses were as follows:
Set 1: 0.66 ml of a 1 g/l solution for each dye: Direct Red 80, Direct Green 26, Direct Black 22
Set 2: 0.33 ml of a 1 g/l dye solution for Direct Violet 51 and Direct Yellow 86 and 0.66 ml of a 1 g/l dye solution of Direct Blue 244
Set 3: 0.66 ml of a 1 g/l solution for each dye: Direct Blue 71, Direct Blue 106, Direct Yellow 27

Groups of three dyes were tested using the method described above. The conditions being repetitions of those described above for examples 1-6 mutatis mutandis, with ex. 17 as 1&7, ex.18 as 2&8, ex. 19 as 3&9, ex. 20 as 4,10, ex 21 as 5, 13, and ex.22 as 6 & 14.

As with the experiments discussed above, lower figures indicate better results.

The results, seen below (Table 3) show that the DTI benefit obtained from the combination of DTI polymer and catalyst is greater than that obtained for either the catalyst or DTI polymer alone. These results were expressed as the Delta L to prevent differences in colour from affecting the results.

TABLE 3
Delta L of White Pickup Monitor after Wash:

| | Delta L of White Pickup | | |
|---|---|---|---|
| | Monitor after Wash | | |
| Example | Set 1 | Set 2 | Set 3 |
| 17 Control | 30.15 | 24.79 | 20.68 |
| 18 Catalyst | 21.08 | 8.59 | 14.64 |
| 19 PVP | 18.46 | 21.44 | 8.3 |
| 20 PVP + Catalyst | 14.36 | 5.66 | 6.38 |
| 21 PVPy-NO | 17.11 | 21.89 | 7.47 |
| 22 PVPy-NO + Catalyst | 10.8 | 5.57 | 5.85 |

The reflectance spectra of these samples were also measured and the K/S values calculated. The sum of K/S between 400 and 700 nm can be seen below in Table 4. Lower values indicate less dye pickup.

TABLE 4
Sum K/S 400-700 nm

| | Sum K/S 400-700 nm | | |
|---|---|---|---|
| Example | Set 1 | Set 2 | Set 3 |
| 17 Control | 88.00 | 40.56 | 39.53 |
| 18 Catalyst | 29.04 | 9.07 | 20.22 |
| 19 PVP | 17.94 | 21.95 | 12.43 |
| 20 Catalyst + PVP | 11.76 | 3.10 | 9.51 |
| 21 PVPy-NO | 15.94 | 24.11 | 10.72 |
| 22 Catalyst + PVPy-NO | 6.60 | 3.52 | 8.89 |

### Example 23

The cloths used in examples 17-22 were also panelled. A set of 4 cloths was set out in a light-box using D65 illumination. The 4 cloths were Control, catalyst, DTI polymer and catalyst+DTI polymer, labelled A,B,C,D.

The panellists were asked to say which cloth exhibited the least dye pickup. Each panellist assessed 3 replicate sets of cloths for each dye mix. 10 panellists were used in all resulting in 30 measurements for each dye-set for each DTI polymer in total. The results are in table 5 below.

TABLE 5

Number of times picked as
having least dye transfer

| | | Catalyst | DTI | Catalyst + |
|---|---|---|---|---|
| Dye set | Control | only | only | DTI |
| Set 1 PVP | 0 | 3 | 11 | 16 |
| Set 1 PVPy-NO | 0 | 0 | 2 | 28 |
| Set 2 PVP | 0 | 0 | 0 | 30 |
| Set 2 PVPy-NO | 0 | 0 | 0 | 30 |
| Set 3 PVP | 0 | 2 | 6 | 22 |
| Set 3 PVPy-NO | 0 | 2 | 9 | 19 |

### Example 24

The sensitivity of a range of anti dye-transfer systems to changes in surfactant type was investigated using shaker-bath experiments, at 100 rpm, in 40 C liquor for 30 mins. Each experiment used 100 mls wash solution comprising a balance of demin water, a total 1 g/l surfactant (LAS Petrelab 550 and NI Synperonic A7)ranging from 1 g/l to 1 g/l NI (with mixtures in the middle). The liquor also comprised, 0.522 g/l Na₂CO₃, 0.87 g/l STP, 0.2 mls of a 1 g/l solution of dye, 0.035 g/l solution of polymer or 1 microM catalyst+0.5 mM H2O2.

Samples were 13×13 cm pieces of ECE desized mercerised non-fluorescent cotton sheeting which had been rinsed in excess demineralised water and tumble dried.

All fabrics were measured after washing on an ICS Texicon Spectraflash 500 which was calibrated using the following settings:
UV Excluded—420 nm cut-off
Specular Included

Each monitor was measured through four thicknesses of cloth with the unwashed white fabric as the reference standard. Each monitor was measured twice and the average of these measurements was taken to be the value of that monitor.

Reflectance values were taken and converted into delta E values using the 40 ptspec analysis programme. The lowest scores are the best results and are underlined.

Results are given in Table 6.

TABLE 6

| | | % LAS | | | | | |
|---|---|---|---|---|---|---|---|
| | | 100 | 80 | 60 | 40 | 20 | 0 |
| | | % Nonionic | | | | | |
| | | 0 | 20 | 40 | 60 | 80 | 100 |
| D Black 22 | PVP | 8.15 | 7.26 | 5.48 | 3.43 | 3.35 | 3.53 |
| | PVPy-NO | 4.98 | 3.77 | 2.77 | 1.98 | 1.74 | 1.88 |
| | PCM-VPy | 3.32 | 2.83 | 2.22 | 2.15 | 2.13 | 2.2 |
| | Catalyst | 1.39 | 1.4 | 1.27 | 1.21 | 1.1 | 1.11 |
| | Control | 9.62 | 10.37 | 9.67 | 9.30 | 9.58 | 5.45 |
| D Blue 218 | PVP | 4.77 | 4.95 | 4.35 | 2.8 | 2.85 | 2.68 |
| | PVPy-NO | 4 | 3.17 | 1.64 | 1.51 | 1.86 | 1.85 |
| | PCM-VPy | 2.7 | 1.78 | 1.43 | 1.46 | 1.52 | 1.74 |
| | Catalyst | 2.01 | 1.98 | 2.14 | 2.2 | 2.13 | 3.07 |
| | Control | 5.34 | 5.23 | 4.90 | 4.97 | 5.04 | 4.79 |
| D Green 26 | PVP | 9.15 | 6.06 | 1.93 | 1.21 | 1.22 | 1.63 |
| | PVPy-NO | 7.7 | 3.94 | 1.45 | 1.39 | 1.35 | 1.47 |
| | PCM-VPy | 5.59 | 2.46 | 1.21 | 1.31 | 1.22 | 1.33 |
| | Catalyst | 3.24 | 3.21 | 3.2 | 3.44 | 3.65 | 2.83 |
| | Control | 12.75 | 12.36 | 12.49 | 12.82 | 11.96 | 4.18 |
| D Red 89 | PVP | 14.5 | 16.22 | 10.74 | 6.01 | 6.05 | 5.56 |
| | PVPy-NO | 12.87 | 9.59 | 5.35 | 2 | 1.27 | 1.68 |
| | PCM-VPy | 12.38 | 10.3 | 5.43 | 3.88 | 3.71 | 3.74 |
| | Catalyst | 4.58 | 4.88 | 4.79 | 4.97 | 5.61 | 10.16 |
| | Control | 14.31 | 14.92 | 15.44 | 14.59 | 15.74 | 12.78 |
| D Violet 47 | PVP | 16.17 | 17.02 | 10.85 | 4.5 | 4.21 | 3.94 |
| | PVPy-NO | 12.42 | 6.35 | 2.6 | 1.72 | 1.44 | 1.72 |
| | PCM-VPy | 12.27 | 7.39 | 2.99 | 2.36 | 2.32 | 2.13 |
| | Catalyst | 10.45 | 10.4 | 12.1 | 11.62 | 11.63 | 15.05 |
| | Control | 18.48 | 19.00 | 17.82 | 16.56 | 17.55 | 16.66 |
| D Yellow 50 | PVP | 17.8 | 17.42 | 7.86 | 2.05 | 2.06 | 1.65 |
| | PVPy-NO | 13.07 | 13.84 | 5.49 | 0.7 | 1.35 | 1.22 |
| | PCM-VPy | 14.01 | 10.01 | 3.96 | 2.81 | 2.78 | 2.48 |
| | Catalyst | 11.6 | 11.27 | 11.46 | 9.83 | 10.8 | 12.87 |
| | Control | 14.06 | 15.17 | 15.20 | 14.86 | 15.62 | 13.68 |
| Sum | Control | 74.56 | 77.05 | 75.52 | 73.1 | 75.49 | 57.54 |
| | PVP | 70.54 | 68.93 | 41.21 | 20 | 19.74 | 18.99 |
| | PVPy-NO | 55.04 | 40.66 | 19.3 | 9.3 | 9.01 | 9.82 |
| | PCM-VPy | 50.27 | 34.77 | 17.24 | 13.97 | 13.68 | 13.62 |
| | Catalyst | 33.27 | 33.14 | 34.96 | 33.27 | 34.92 | 45.09 |
| Average | Control | 12.43 | 12.84 | 12.59 | 12.18 | 12.58 | 9.59 |
| | PVP | 11.76 | 11.49 | 6.87 | 3.33 | 3.29 | 3.17 |
| | PVPy-NO | 9.17 | 6.78 | 3.22 | 1.55 | 1.50 | 1.64 |
| | PCM-VPy | 8.38 | 5.80 | 2.87 | 2.33 | 2.28 | 2.27 |
| | Catalyst | 5.55 | 5.52 | 5.83 | 5.55 | 5.82 | 7.52 |

From Table 6 it can be seen that for the polymers higher scores (worse results) are, on average, obtained in the anionic rich formulations. For the catalyst, higher scores (worse results) are, on average, obtained in nonionic rich systems.

1. A composition comprising:
a) a dye transfer inhibition agent, and,
b) a ligand having the structure: 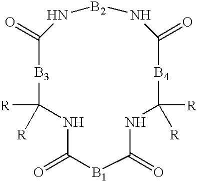
wherein:
B₁, B₃ and B₄ each represent a bridging group having zero, one two or three carbon containing nodes for substitution, and B₂ represents a bridging group having at least one carbon containing node for substitution, each said node containing a C(R), C(R₁)(R₂) or C(R)₂,
each R substituent is the same or different from the remaining R substituents and
(1) is selected from the group consisting of alkyl, alkenyl, cycloalkyl, cycloalkenyl, aryl, alkynyl, alkylaryl, halogen, alkoxy, phenoxy and combinations thereof, or
(2) from a substituted or unsubstituted benzene ring of which two carbons on the ring form nodes in the B-unit.

2. The composition according to claim 1, further comprising a transition metal ion, an axial ligand, and an alkali metal counter-ion.

3. The composition according to claim 2, wherein the axial ligand is selected from the group consisting of water and halide.

4. The composition according to claim 2, wherein the metal is selected from the group consisting of Fe, Mn, Cr, Cu, Co, Ni, Mo, Zn and W.

5. The composition according to any one of claim 1, further comprising a peroxygen source.

6. The composition according to claim 5, wherein the peroxygen source is hydrogen peroxide or a precursor thereof.

7. The composition according to claim 2, further comprising surfactant and builder.

8. The composition according to claim 2 comprising both anionic and nonionic surfactant in a weight ratio (on surfactant) of 10-90% anionic: 90-10% nonionic.

9. The composition according to claim 2, in solid form.

10. The composition according to anyone of claim 1, wherein the dye transfer inhibiting agent comprises a nitrogen-containing, dye binding polymer.

11. The composition according to claim 10, wherein the nitrogen containing dye binding polymer is selected from polymers and co-polymers of vinylpyrrolidone, vinylpyridine N-oxide, vinylimidazole, vinylpyridinium chloride and mixtures thereof, and zwitterionic polymers.

12. The composition according to claim 2, further comprising a peroxygen source.

13. The composition according to claim 3, further comprising a peroxygen source.

14. The composition according to claim 4, further comprising a peroxygen source.

15. The composition according to claim 2, wherein the dye transfer inhibiting agent comprises a nitrogen-containing, dye binding polymer.

16. The composition according to claim 3, wherein the dye transfer inhibiting agent comprises a nitrogen-containing, dye binding polymer.

17. The composition according to claim 5, wherein the dye transfer inhibiting agent comprises a nitrogen-containing, dye binding polymer.

18. The composition according to claim 7, wherein the dye transfer inhibiting agent comprises a nitrogen-containing, dye binding polymer.

19. The composition according to claim 8, wherein the dye transfer inhibiting agent comprises a nitrogen-containing, dye binding polymer.

20. The composition according to claim 14, wherein the dye transfer inhibiting agent comprises a nitrogen-containing, dye binding polymer.
